(19) United States
(12) Patent Application Publication
(10) Pub. No.: US 2022/0410838 A1
(43) Pub. Date: Dec. 29, 2022

(54) THEFT-DETERRENT SYSTEM FOR CONTAINER VEHICLE

(71) Applicant: Heil Trailer International, LLC, Athens, TN (US)

(72) Inventors: Duane Langford, Athens, TN (US); Nathan Langford, Athens, TN (US)

(73) Assignee: Heil Trailer International, LLC, Athens, TN (US)

(21) Appl. No.: 17/564,798

(22) Filed: Dec. 29, 2021

Related U.S. Application Data
(60) Provisional application No. 63/215,007, filed on Jun. 25, 2021.

(51) Int. Cl. B60R 25/01; B60R 25/34; B60R 25/33; G01S 19/16

(52) U.S. Cl. CPC B60R 25/01; B60R 25/34; B60R 25/33; G01S 19/16

(57) ABSTRACT

A theft-deterrent assembly for a container vehicle includes a physical barrier that is movable between a closed position that prevents the opening of a discharge port for the product carried in the container, and an open position that allows the opening of the discharge port. A sensor is provided that determines if the physical barrier is in the open position or in the closed position. The sensor is operatively attached to a theft-deterrent controller that is adapted to record the movement of the physical barrier between the open and closed positions upon the occurrence of such movement.

### CROSS-REFERENCE TO RELATED APPLICATION

This application claims the benefit of U.S. Provisional Patent Application No. 63/215,007, which was filed on Jun. 25, 2021.

### FIELD OF THE INVENTION

This invention relates generally to container vehicles for transporting and delivering fluid and particulate products, and more particularly, to a system and assembly for detecting and providing notice of access to the discharge port or ports of such a container vehicle.

### BACKGROUND OF THE INVENTION

Many fluid or particulate products are transported on highways, although they may also be transported by railcar, barge or other means. Container vehicles that are used to transport such commodities may comprise a truck chassis on which a product container is mounted, or they may comprise a tractor and an attached trailer having a product container mounted thereon. Some of these product containers are incorporated into container vehicles used to transport fluid or liquid products such as gasoline, propane or other fuels. Others are incorporated into container vehicles used to transport particulate materials such as agricultural products including grain, corn kernels, beans, flour, sugar, peanuts and the like, or intermediate products for various industrial uses including plastic pellets, coke, lime, silica gel, powdered acid resins, rare earth powders and the like.

All of these container vehicles include product containers with discharge ports through which the products being transported in the product containers may be discharged. Frequently, the product containers on such container vehicles will include multiple compartments, each adapted to hold a particular product, or a particular quantity of a product. In this circumstance, each compartment of the product container will have its own discharge port.

It is necessary for the operators of these container vehicles to be able to access the discharge ports in order to deliver products to the supplier's customers. Although most such operators are honest and trustworthy, some have been known to offload some portion of the products at unauthorized locations. Such theft is expensive and potentially damaging to the supplier's customer relations when a customer receives none or only part of the product it has ordered.

### Advantages of the Invention

Among the advantages of the invention is that it provides a system and assembly to detect in real time and to record when a discharge port of a container vehicle is accessed. In a preferred embodiment of the invention, the system is adapted to communicate with a global positioning system to record the specific location of the container vehicle when the discharge port is accessed. In addition, the system may be adapted to communicate with a fleet management system or other party remote from the container vehicle to notify such party that a discharge port has been accessed. Other advantages and features of this invention will become apparent from an examination of the drawings and the ensuing description.

Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “attached”, “connected” and “interconnected”, refer to a relationship wherein structures are secured or attached to one another either directly or indirectly through intervening structures, as well as both moveable and rigid attachments or relationships. The terms “operatively attached” and “operatively connected” describe such an attachment, coupling or connection that allows the pertinent structures to operate as intended by virtue of that relationship.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

### SUMMARY OF THE INVENTION

The invention is a theft-deterrent assembly for a container vehicle which comprises a Physical barrier that is movable between a closed position that prohibits access to, or prevents the opening of, the discharge port or ports of the product container, and an open position that allows access to, or allows the opening of, the discharge port or ports of the product container. A sensor is provided that determines if the physical barrier is in the open position or in the closed position. This sensor is operatively attached to a theft-deterrent controller that is adapted to record the movement of the physical barrier between the open and closed positions upon the occurrence of such movement of the physical barrier. In a preferred embodiment of the invention, the record of the movement of the physical barrier between the open and closed positions will include the time at which such movement occurred. In another preferred embodiment of the invention, the theft-deterrent controller is adapted to transmit a signal to a remote party that the physical barrier has been moved between the open and closed positions. In yet another preferred embodiment of the invention, the theft-deterrent controller is operatively attached to a global positioning system and is adapted to record and transmit to the remote party the location of the container vehicle at the time the physical barrier was moved between the open and closed positions.

In order to facilitate an understanding of the invention, the preferred embodiment of the invention, as well as the best mode known by the inventors for carrying out the invention, is illustrated in the drawings, and a detailed description thereof follows. It is not intended, however, that the invention be limited to the particular embodiment described or to use in connection with the apparatus illustrated herein. Therefore, the scope of the invention contemplated by the inventors includes all equivalents of the subject matter described and claimed herein, as well as various modifications and alternative embodiments such as would ordinarily occur to one skilled in the art to which the invention relates. The inventors expect skilled artisans to employ such variations as seem to them appropriate, including the practice of the invention otherwise than as specifically described herein. In addition, any combination of the elements and components of the invention described herein in any possible variation is encompassed by the invention, unless otherwise indicated herein or clearly excluded by context.

### BRIEF DESCRIPTION OF THE DRAWINGS

The presently preferred embodiment of the invention is illustrated in the accompanying drawings, in which like reference numerals represent like parts throughout, and wherein:

FIG. 1 is a side view of a conventional fluid container trailer that has been equipped with the preferred double-bar interlock assembly of the invention.

FIG. 2 is a perspective view of the preferred double-bar interlock assembly, showing the assembly in a closed position that prohibits access to or opening of the discharge ports.

FIG. 3 is a perspective view of the preferred double-bar interlock assembly, showing the assembly in an open position that permits access to and opening of the discharge ports.

FIG. 4 is an enlarged view of a portion of the preferred double-bar interlock assembly, showing the location and placement of the preferred proximity sensor, with a portion of the proximity sensor enclosure shown in phantom lines to reveal the proximity sensor inside.

FIG. 5 is a circuit diagram showing the attachment of the preferred proximity sensor to the electrical system of the container vehicle.

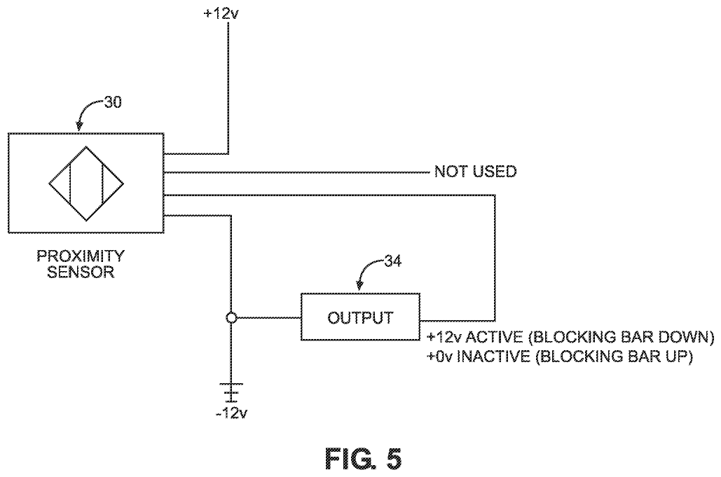

### DESCRIPTION OF THE PREFERRED EMBODIMENTS OF THE INVENTION

This description of preferred embodiments of the invention is intended to be read in connection with the accompanying drawings, which are to be considered part of the entire written description of this invention. The drawing figures are not necessarily to scale, and certain features of the invention may be shown exaggerated in scale or in somewhat schematic form in the interest of clarity and conciseness.

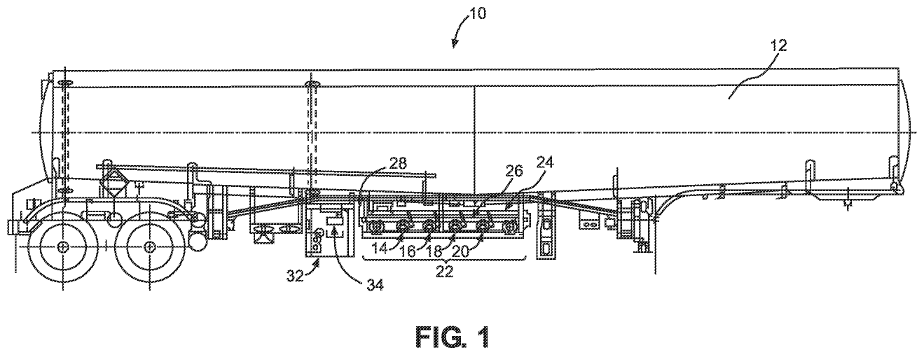

As shown in FIG. 1, container trailer assembly 10 includes container 12, which is divided into four fluid product compartments (not shown). Discharge ports 14, 16, 18 and 20 are provided in discharge port bank 22 that is located below container 12. Each of the discharge ports is operatively connected to and in fluid communication with one of the fluid product compartments.

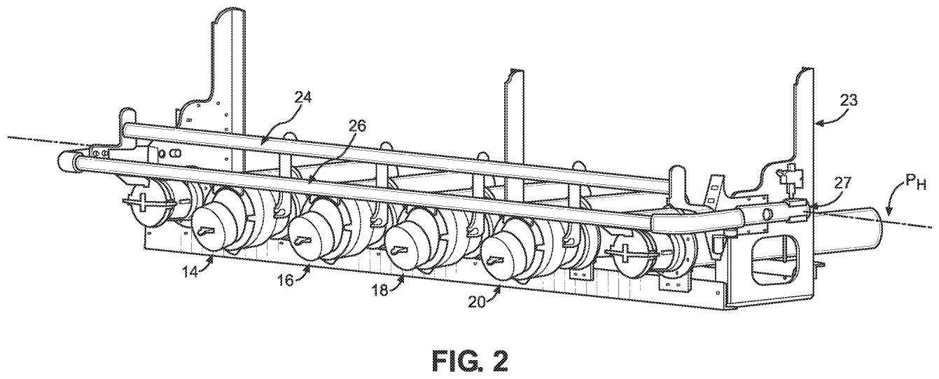

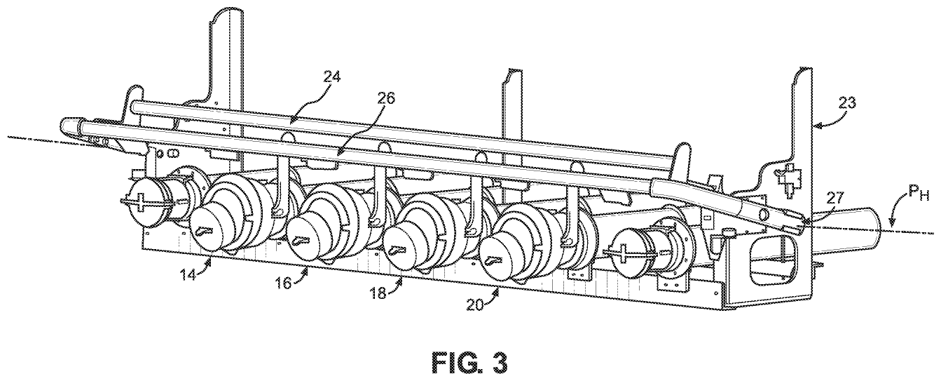

The preferred double-bar interlock assembly is attached to frame component 23 of container trailer assembly 10. This double-bar interlock assembly includes actuation bar 24 that is operatively connected to blocking bar 26. Blocking bar 26 is attached to frame component 23 by a pair of hinges, one of which, hinge 27, is shown in FIGS. 2 and 3. This double-bar interlock assembly is configured so that when actuation bar 24 is moved by an operator of the container vehicle from the actuation bar closed position shown in FIG. 2 to the actuation bar open position shown in FIG. 3, blocking bar 26 will pivot on its hinges about substantially horizontal pivot axis PH to move from the blocking bar closed position, in which it prohibits or blocks access to the discharge ports, to the blocking bar open position which allows access to the discharge ports. This preferred blocking bar physically interferes with the discharge valves of the discharge ports when in the blocking bar closed position. In another embodiment of the invention (not shown), the blocking bar may be pivotally attached at a first end so as to pivot about a substantially vertical pivot axis on a first side of the discharge port bank between an open position that allows access to the discharge ports and a closed position that engages a latch component on the second end of the blocking bar with a latch assembly on the second side of the discharge port bank so as to physically interfere with the discharge valves of the discharge ports. In yet another embodiment of the invention (also not shown), the blocking bar may operate to close valves in the discharge ports when in the closed position.

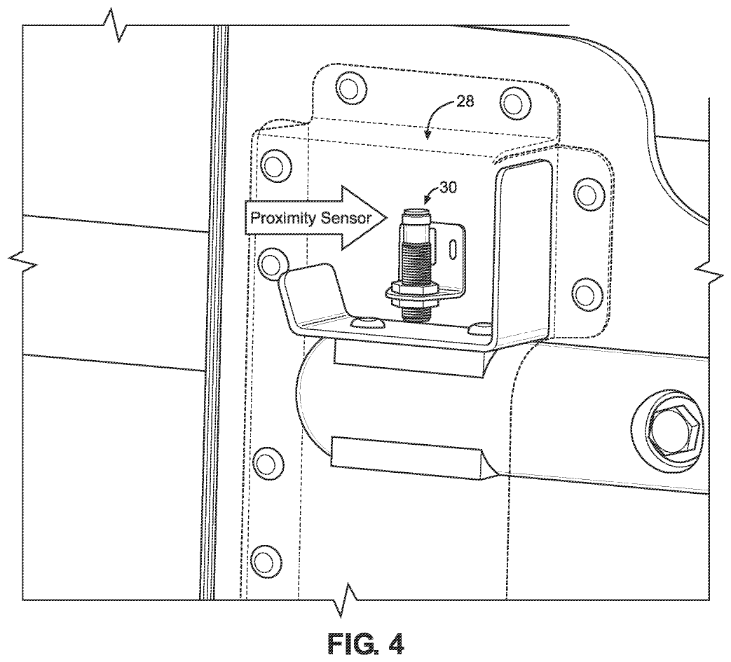

To the left of discharge port bank 22 (as viewed in FIG. 1) is proximity sensor enclosure 28 which encloses proximity sensor 30 (shown in FIG. 4). Also shown in FIG. 1 is controls enclosure 32, which encloses the controls for operating the discharge ports and other features of trailer assembly 10, and also includes theft-deterrent controller 34. The theft-deterrent controller may include a processor, a memory component and other components for running an application, for communicating with a global positioning system and for transmitting a signal to a third party that is remote from the container vehicle. Various circuits, including but not limited to power supply circuitry, may also be associated with and operatively connected to the theft-deterrent controller. Numerous commercially available microprocessors can be configured to perform the functions of the theft-deterrent controller. It should be appreciated that the theft-deterrent controller could readily be embodied in a general purpose computer or machine microprocessor capable of controlling numerous functions of trailer assembly 10.

When actuation bar 24 is moved to the actuation bar open position (i.e., upwardly, as shown in the drawings), blocking bar 26 will also move to the blocking bar open position. This sets normally-open proximity sensor 30 to an open state, which causes theft-deterrent controller 34 to record the time, and preferably the location of the container vehicle (using access to a global positioning system). In a preferred embodiment of the invention, theft-deterrent controller 34 will also cause an “open” signal to be sent to a third party that is remote from the container vehicle. Then, when the actuation bar 24 is moved to the actuation bar closed position shown in FIGS. 1 and 2, blocking bar 26 will also move to the blocking bar closed position. This sets proximity sensor 30 to a closed state, which causes theft-deterrent controller 34 to record the time, and preferably the location of the container vehicle. In a preferred embodiment of the invention, theft-deterrent controller 34 will also cause a “closed” signal to be sent to a third party that is remote from the container vehicle. The “open” and “closed” status information may also be stored in the memory component of theft-deterrent controller 34 for retrieval at the container vehicle terminal or other location.

Because the proximity sensor is not accessible to the vehicle operator (i.e., it is enclosed in tamper-proof sensor enclosure 28), it is impossible for a vehicle operator or other person to override or tamper with the theft-deterrent system without cause obvious damage to trailer assembly 10. The invention thus provides a relatively simple system and assembly for detecting in real time and recording when a discharge port is accessed. Furthermore, in a preferred embodiment of the invention, the system automatically communicates with a fleet management system or other party remote from the container vehicle to notify such party that a discharge port has been accessed.

Although this description contains many specifics, these should not be construed as limiting the scope of the invention but as merely providing illustrations of the presently preferred embodiment thereof, as well as the best mode contemplated by the inventors of carrying out the invention. The invention, as described and claimed herein, is susceptible to various modifications and adaptations, as would be understood by those having ordinary skill in the art to which the invention relates.

What is claimed is:

1. A theft-deterrent assembly for a container vehicle having a product container for containing a product and a discharge port through which the product in the product container may be discharged, said theft-deterrent assembly comprising:
(a) a physical barrier that is movable between a closed position that prevents the opening of the discharge port of the product container and an open position that allows the opening of the discharge port of the product container;
(b) a sensor that is adapted to determine if the physical barrier is in the open position or in the closed position;
(c) a theft-deterrent controller to which the sensor is operatively attached, said theft-deterrent controller being adapted to record the movement of the physical barrier between the open and closed positions upon the occurrence of such movement of the physical barrier between the open and closed positions.

2. The theft-deterrent assembly of claim 1 wherein the sensor is enclosed in tamper-proof sensor enclosure.

3. The theft-deterrent assembly of claim 1 wherein the record of the movement of the physical barrier between the open and closed positions will include the time at which such movement occurred.

4. The theft-deterrent assembly of claim 1 wherein the theft-deterrent controller is operatively attached to a global positioning system and is adapted to record the location of the container vehicle at the time the physical barrier was moved between the open and closed positions.

5. The theft-deterrent assembly of claim 1 wherein the theft-deterrent controller is adapted to transmit a signal to a remote party that the physical barrier has been moved between the open and closed positions, upon the occurrence of such movement between the open and closed positions.

6. The theft-deterrent assembly of claim 5 wherein the signal transmitted to the remote party by the theft-deterrent controller that the physical barrier has been moved between the open and closed positions will include the time at which such movement occurred.

7. The theft-deterrent assembly of claim 5 wherein the theft-deterrent controller is operatively attached to a global positioning system and is adapted to transmit to the remote party the location of the container vehicle at the time the physical barrier was moved between the open and closed positions.

8. The theft-deterrent assembly of claim 1:
(a) wherein the physical barrier comprises a blocking bar that is adapted to move between the closed position that prevents the opening of the discharge port of the product container and the open position that allows the opening of the discharge port of the product container;
(b) which includes an actuation bar that is operatively connected to the blocking bar and adapted to be moved between an actuation bar closed position that moves the blocking bar to the closed position and an actuation bar open position that moves the blocking bar from the closed position to the open position which allows access to the discharge port.

9. The theft-deterrent assembly of claim 8 wherein the blocking bar is attached to a frame component of the container vehicle by a pair of hinges so that:
(a) when the actuation bar is moved from the actuation bar closed position to the actuation bar open position, the blocking bar will pivot on its hinges about a substantially horizontal pivot axis to move from the blocking bar closed position to the blocking bar open position;
(b) when the actuation bar is moved from the actuation bar open position to the actuation bar closed position, the blocking bar will pivot on its hinges to move from the blocking bar open position to the blocking bar closed position.

10. The theft-deterrent assembly of claim 1 wherein the sensor is a proximity sensor that is adapted to be:
(a) set to an open state when the physical barrier is moved to the open position, which causes the theft-deterrent controller to record the time at which the physical barrier was moved to the open position;
(b) set to a closed state when the physical barrier is moved to the closed position, which causes the theft-deterrent controller to record the time at which the physical barrier was moved to the closed position.

11. The theft-deterrent assembly of claim 10 wherein the setting of the proximity sensor to the open state will cause the theft-deterrent controller to record the location of the container vehicle using access to a global positioning system.

12. The theft-deterrent assembly of claim 10 wherein the setting of the proximity sensor to the open state will cause the theft-deterrent controller to send an “open” signal to the remote party.

13. The theft-deterrent assembly of claim 10 wherein the setting of the proximity sensor to the open state will cause an open state status to be stored in a memory component of the theft-deterrent controller.

14. The theft-deterrent assembly of claim 10 wherein the setting of the proximity sensor to the closed state will cause the theft-deterrent controller to record the location of the container vehicle using access to a global positioning system.

15. The theft-deterrent assembly of claim 10 wherein the setting of the proximity sensor to the closed state will cause the theft-deterrent controller to send a “closed” signal to the remote party.

16. The theft-deterrent assembly of claim 10 wherein the setting of the proximity sensor to the closed state will cause a closed state status to be stored in a memory component of the theft-deterrent controller.
